(19) United States
(12) Patent Application Publication
(10) Pub. No.: US 2008/0276480 A1
(43) Pub. Date: Nov. 13, 2008

(54) RACK FOR DRIERS

(76) Inventor: Wuu-Cheau Jou, Dali City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/746,723

(22) Filed: May 10, 2007

(51) Int. Cl. A01F 25/12

(52) U.S. Cl. 34/239

(57) ABSTRACT

A rack for driers includes a support with a Y-axis tube set connected thereto and an inlet unit is mounted to the Y-axis tube set so that two connection members are respectively connected thereto. A Z-axis tube is connected to a vertical sleeve unit on the Y-axis tube set and an X-axis tube is connected to a horizontal sleeve unit on the Z-axis tube. Two driers are connected to two drier bases on the X-axis tube. The two driers are connected to the two connection members by hoses. The positions of the driers are adjusted in three directions and the inlet unit is rotated about the Y-axis tube set.

### FIELD OF THE INVENTION

The present invention relates to a rack having multiple sleeve units on an X-axis tube, a Y-axis tube and a Z-axis tube so as to provide a wider range of working area.

### BACKGROUND OF THE INVENTION

A conventional rack 1 for driers is shown in FIGS. 19 to 23, and generally includes a support 10, a Y-axis tube 11 and an X-axis tube 31, wherein an outer tube 12 is movably mounted to the Y-axis tube 11 and can be positioned by a screw 121. An inlet unit 20 and a movable member 30 are respectively connected to the outer tube 12, wherein the inlet unit 20 is connected with an inlet pipe 21 connected with a compressor (not shown). Two hoses 22 are respectively connected to the inlet unit 20 so as to provide two driers 40. The X-axis tube 31 is movably connected to the movable member 30 and two drier bases 32 are movably connected to the X-axis tube 31 so that the two driers 40 are connected to the drier bases 32. It is noted that the two driers 40 can only be moved along the X-axis tube 31 to adjust the working areas 400 or be pivoted about the X-axis tube 31. The two driers 40 are always located on the same horizontal positions and the X-axis tube 31 cannot be rotated about Z-axis 301. Besides, the inlet unit 20 is located on the outer tube 12 so that the inlet unit 20 moves with the outer tube 12. When moving the outer tube 12, the inlet pipe 21 is pulled and might drag down the rack 1.

The present invention intends to provide a rack for driers and the driers are able to be moved in X, Y, and Z directions. The inlet unit can be rotated in different directions so that the inlet pipe can be conveniently arranged.

### SUMMARY OF THE INVENTION

The present invention relates to a rack for driers and the rack comprises a support having a top hole and a Y-axis tube set is connected with the top hole. The Y-axis tube set includes a first tube and a second tube which is connected to the first tube by a connection member. An inlet unit has a upright sleeve which is mounted to the first tube and a screw threadedly extends through the upright sleeve. Two connection members are respectively connected to a front end and a top of the inlet unit. A vertical sleeve unit has a vertical sleeve in Y-axis and a horizontal sleeve in Z-axis. The vertical sleeve is movably mounted to the first tube or the second tube, and the vertical sleeve includes a threaded hole. A pressing member has a top member and a threaded hole is defined through the top member. A screw is threadedly connected to the threaded hole and presses the pressing member to a Z-axis tube. A horizontal sleeve unit has a fixed member and a horizontal sleeve, wherein a stepped hole is defined in the fixed member. An X-axis tube extends through the horizontal sleeve and includes a threaded hole so that a screw is threadedly connected to the threaded hole to fix the X-axis tube. A drier base includes a horizontal sleeve and the X-axis tube extends through the horizontal sleeve. A screw extends through an underside of the drier base. A connection member is connected to a top of the drier base and a drier is connected to the connection member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the rack for driers of the present invention;

FIG. 2 is a perspective view to show the rack for driers of the present invention;

FIG. 3 is a plane view to show the rack for driers of the present invention;

FIG. 4 is an exploded view to show the vertical sleeve unit of the present invention;

FIG. 5 is a cross sectional view of the vertical sleeve unit of the present invention;

FIG. 6 shows the horizontal sleeve unit of the present invention;

FIG. 7 shows that the Z-axis tube is movable in Z-axis;

FIG. 8 shows that the Z-axis tube is rotated in Z-axis;

FIG. 9 shows that the Z-axis tube is rotated in Z-axis and the driers are moved with the Z-axis tube;

FIG. 10 shows that the Z-axis tube is movable in Y-axis and rotated in Y-axis;

FIG. 11 shows the pattern of the underside of the side blocks;

FIG. 12 shows another pattern of the underside of the side blocks;

FIG. 13 is an exploded view to show the rotatable set of the present invention;

FIG. 14 is a cross sectional view of the rotatable set of the present invention;

FIG. 15 shows driers are connected to the rack with the rotatable set;

FIG. 16 shows the Z-axis tube of the rotatable set is rotated an angle;

FIG. 17 shows the inlet unit, the vertical sleeve unit, and the horizontal sleeve unit are used with conventional retractable Y-axis tube and outer tube;

FIG. 18 shows the rotatable inlet unit, the vertical sleeve unit, and the horizontal sleeve unit are used with conventional retractable Y-axis tube and outer tube;

FIG. 19 is an exploded view to show a conventional rack for driers;

FIG. 20 shows the conventional rack for driers;

FIG. 21 shows the working area of the two driers of the conventional rack for driers;

FIG. 22 shows a side view of the conventional rack for driers, and

FIG. 23 shows the inlet unit and the inlet pipe of the conventional rack are moved upward.

### DETAILED DESCRIPTION OF THE PREFERRED EMBODIMENT

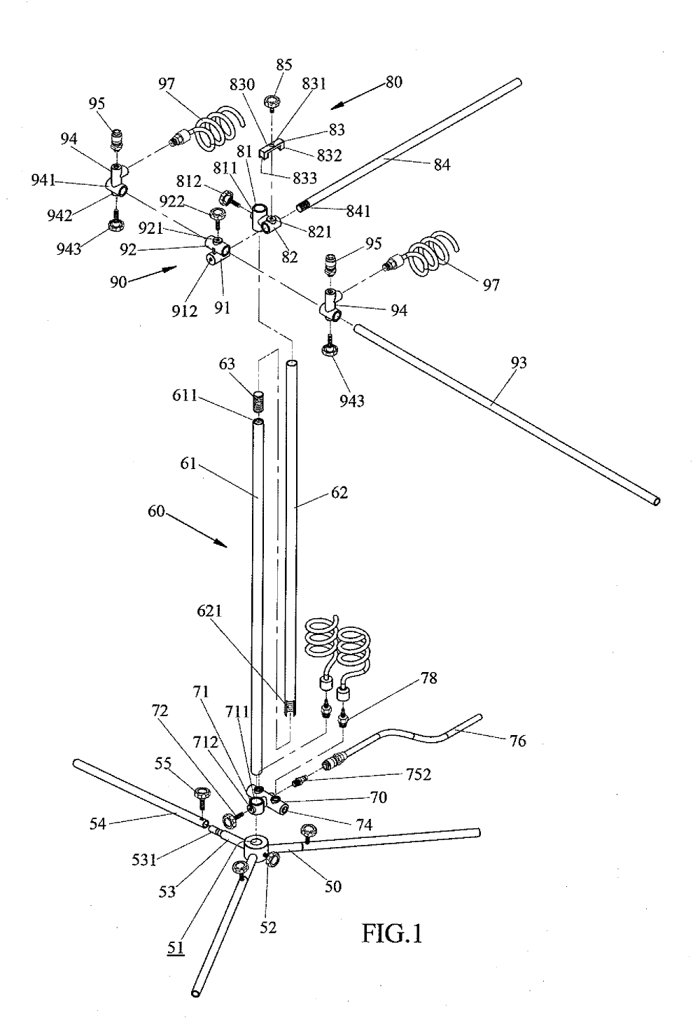

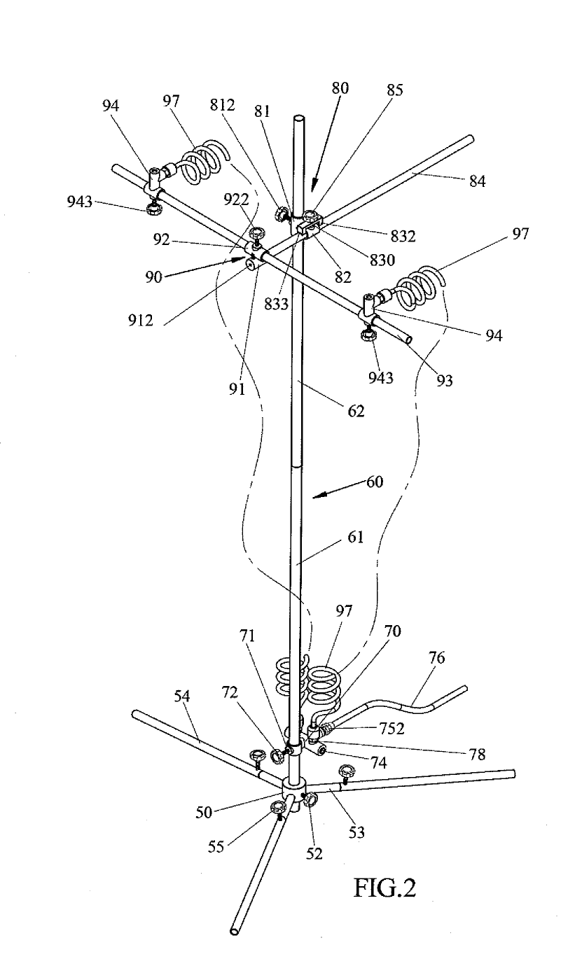

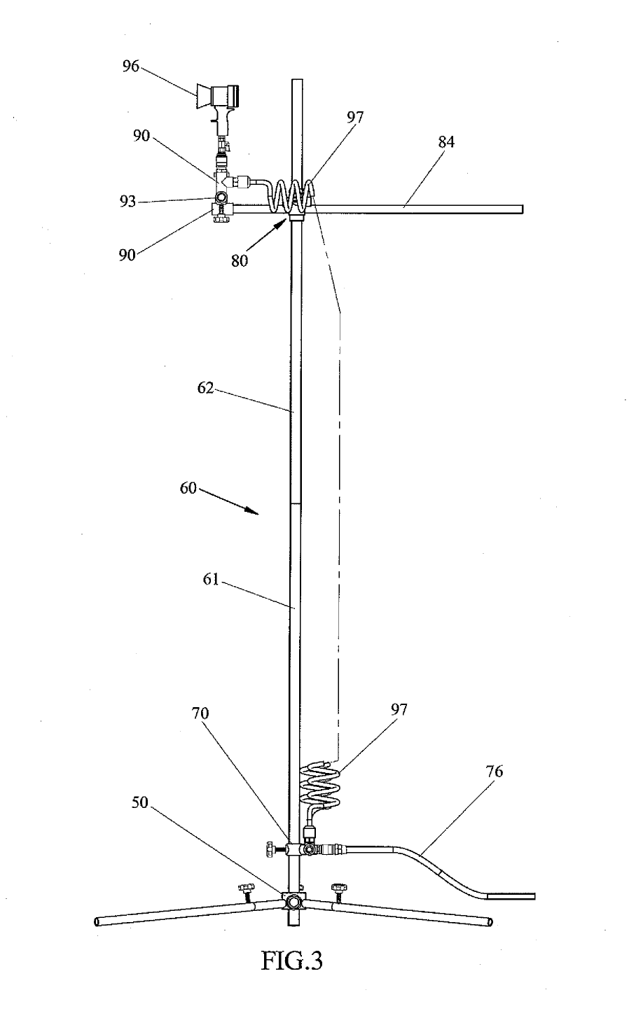

Referring to FIGS. 1 to 3, the rack for driers of the present invention comprises a support 50 which includes a tubular member with a top hole 51 and three legs 53 extend from the tubular member and each leg 53 has a neck so as to be connected with an extension tube 54 by a screw 55.

A Y-axis tube set 60 is connected with the top hole 51 and includes a first tube 61 and a second tube 62 which is connected to the first tube 61 by a connection member 63. The first tube 61 is inserted into the top hole 51 and is fixedly by extending a screw 52 through the tubular member. An inlet unit 70 includes an upright sleeve 71 which includes a passage 711 so as to be mounted to the first tube 61 or the second tube 62, and a screw 72 threadedly extends through a threaded hole 712 in the upright sleeve 71 to position the inlet unit 70. Two connection members 78 are respectively connected to a top of the inlet unit 70 so as to be connected with two hoses, and another connection member 752 is connected to a front end and of the inlet unit 70 so as to be connected with an inlet hose 76 which is connected to a compressor (not shown). Two end nuts 74 seal the two ends of the inlet unit 70.

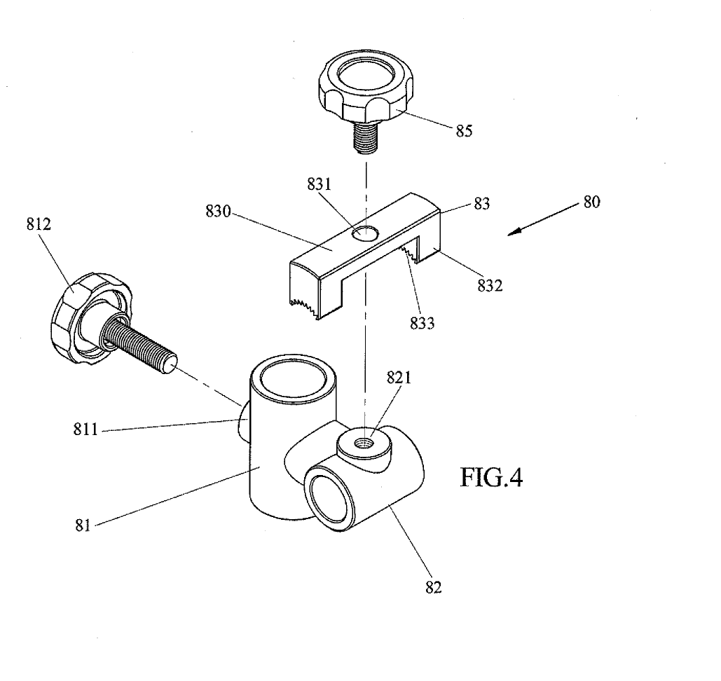

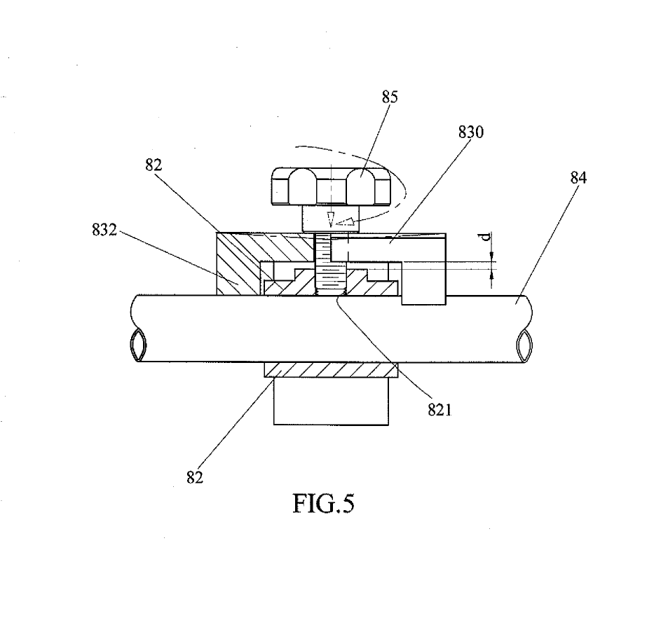

Further referring to FIGS. 4 and 5, a vertical sleeve unit 80 includes a vertical sleeve 81 in Y-axis and a horizontal sleeve 82 in Z-axis. The vertical sleeve 81 is movably mounted to the first tube 61 or the second tube 62. The vertical sleeve 81 includes a threaded hole 821. A pressing member 83 has a top member 830 and a threaded hole 831 is defined through the top member 830. A screw 85 is threadedly connected to the threaded hole 821 and presses the pressing member 83 to a Z-axis tube 84. The pressing member 83 is mounted on the horizontal sleeve 82 and a distance “d” is defined between an underside of the top member 831 and a top surface of the threaded hole 821. Two side blocks 832 extend from two ends of the top member 831 of the pressing member 83, and an underside 833 of each side block 832 is a curved and rough surface which matches with the Z-axis tube 84.

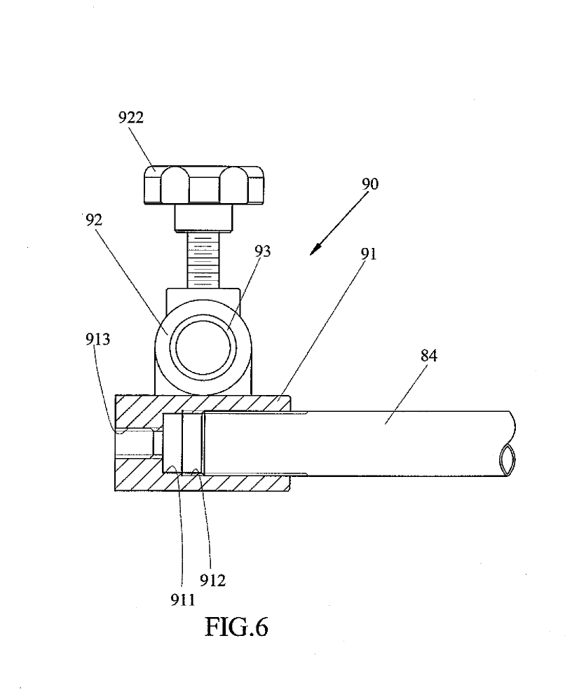

Further referring to FIG. 6, a horizontal sleeve unit 90 includes a fixed member 91 and a horizontal sleeve 92. A stepped hole 911 is defined in the fixed member 91 and includes a first inner threaded portion 912 and a second inner threaded portion 913. The firs inner threaded portion 912 is longer than the second inner threaded portion 913. The Z-axis tube 84 includes a threaded end 841 so as to be threadedly connected to the first inner threaded portion 912. The second inner threaded portion 913 is defined through the horizontal tube 92. An X-axis tube 93 extends through the horizontal sleeve 92 and has a threaded hole 921 so that a screw 922 threadedly connected to the threaded hole 921 to fix the X-axis tube 93.

Two drier bases 94 each include a horizontal sleeve 941 and the X-axis tube 93 extends through the horizontal sleeve 941. A screw 943 threadedly extends through a threaded hole 942 in an underside of the drier base 94 to fix the drier base 94, A connection member 95 is connected to a top of each of the drier bases 94 and two driers 96 are connected to the connection members 95.

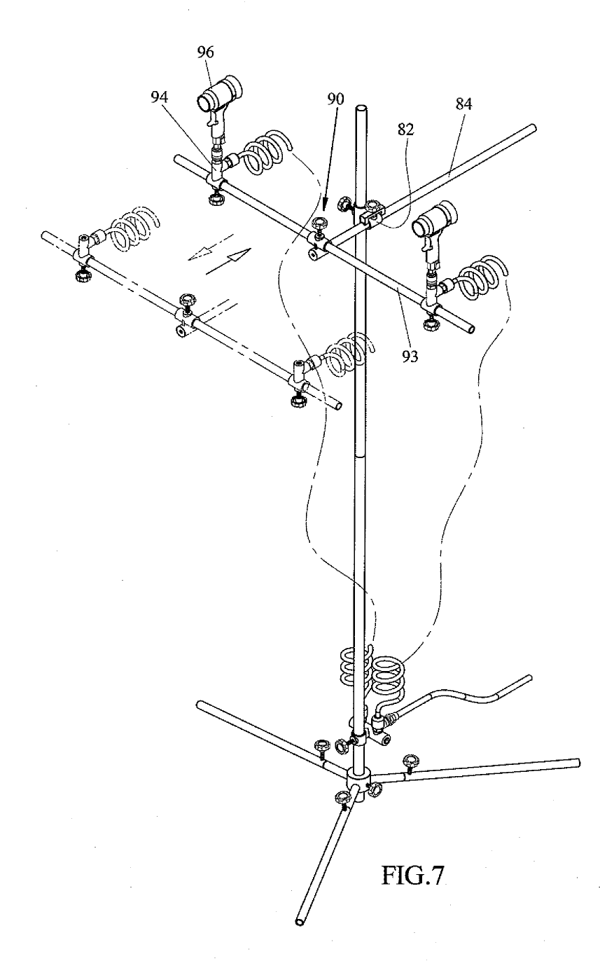

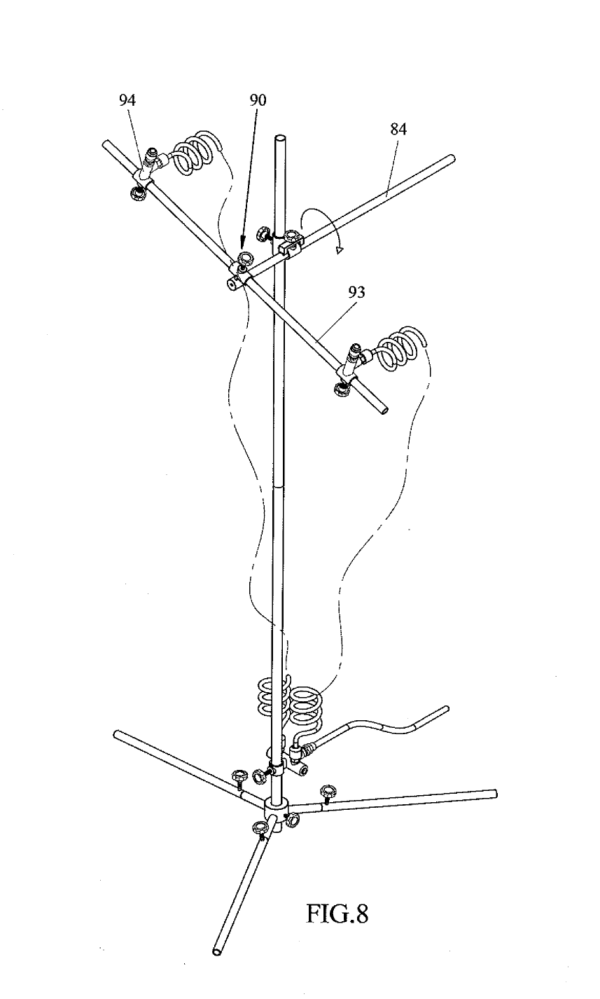

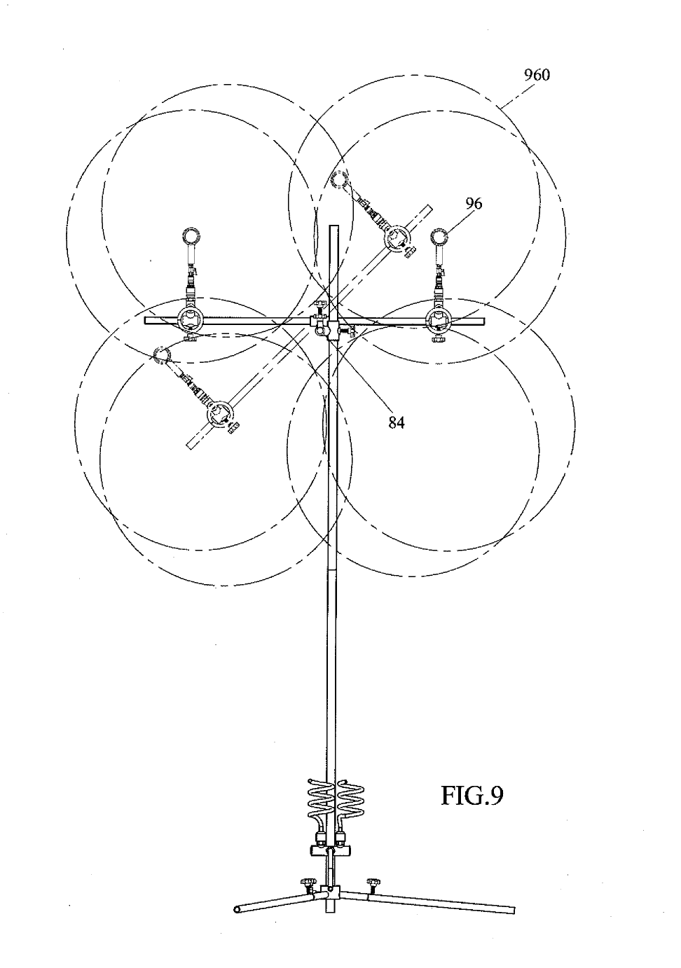

FIG. 7 shows that the Z-axis tube 84 can be moved relative to the horizontal sleeve 82 of the vertical sleeve unit 80 to adjust the distance between the driers 96 and the object (not shown). FIG. 8 shows that the Z-axis tube 84 can be rotatable about the Z-axis to adjust the height of the driers 96. The working areas 960 cover a larger area along with the rotation of the Z-axis tube 84.

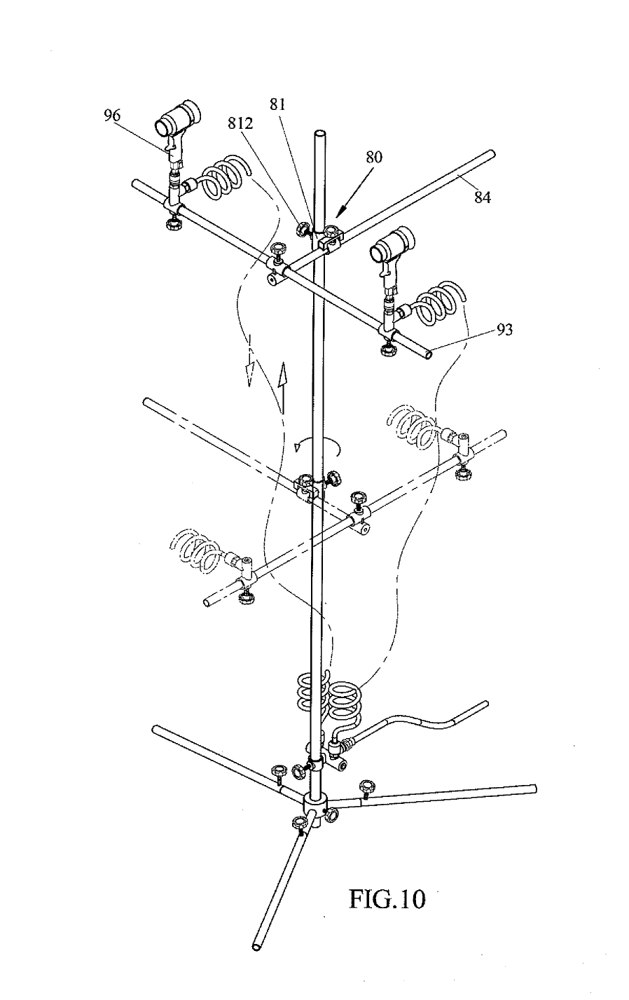

FIG. 10 shows that the Z-axis tube 84 and the X-axis tube 93 are both moved along the Y-axis tube set 60 by controlling the vertical sleeve 81 of the vertical sleeve unit 80. The Z-axis tube 84 and the X-axis tube 93 can be both rotated about the Y-axis tube set 60 to change the directions that the driers 96 face.

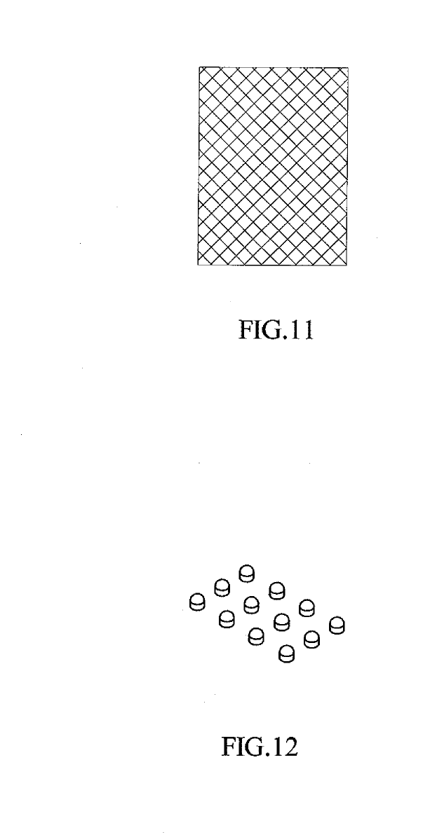

The screw 85 is able to secure the Z-axis tube 84 by contacting the distal end of the screw 85 to the Z-axis tube 84 and by the pressing member 83. The two side blocks 832 are located at two ends of the horizontal sleeve 82 and a distance “d” is defined between the underside of the top member 830 and the threaded hole 821, so that when the screw 85 is tightened, the top member 830 is deformed to let the side blocks 832 to press on the Z-axis tube 84, and then the screw 85 is threadedly connected with the threaded hole 821 to secure the Z-axis tube 84. FIGS. 11, 12 show that the rough surface of the underside 833 of each side block 832 may include netted pattern or bosses so as to increase friction between the side blocks 832 and the Z-axis tube 84.

The inlet unit 70 is located at low position and the movement of the driers 96 in Y-axis does not need to move the inlet unit 70 so that the whole rack is stable on the ground.

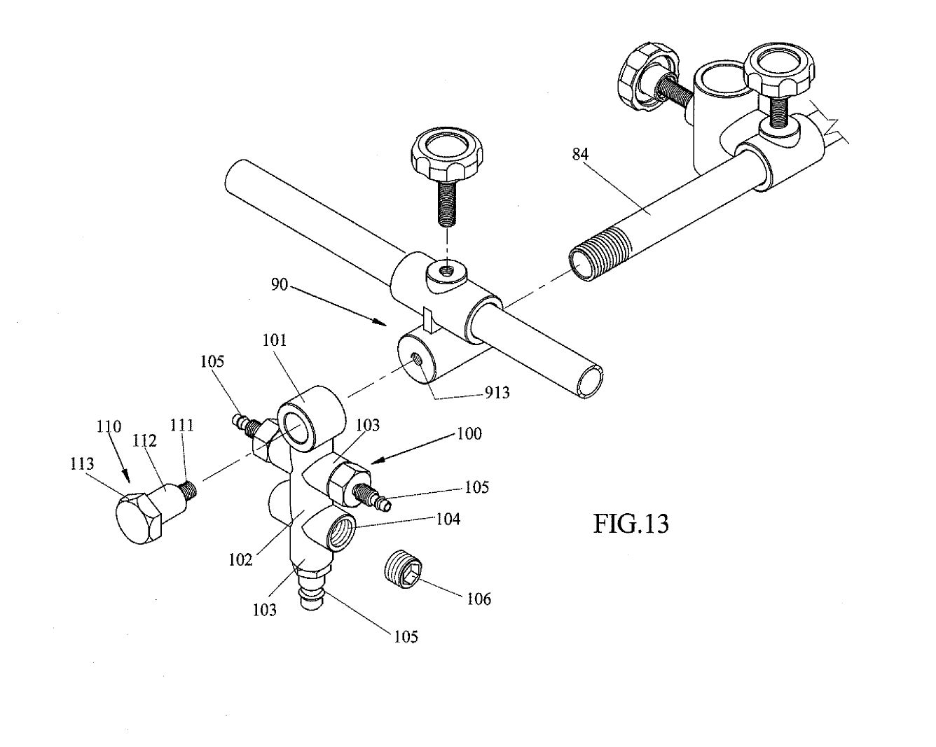

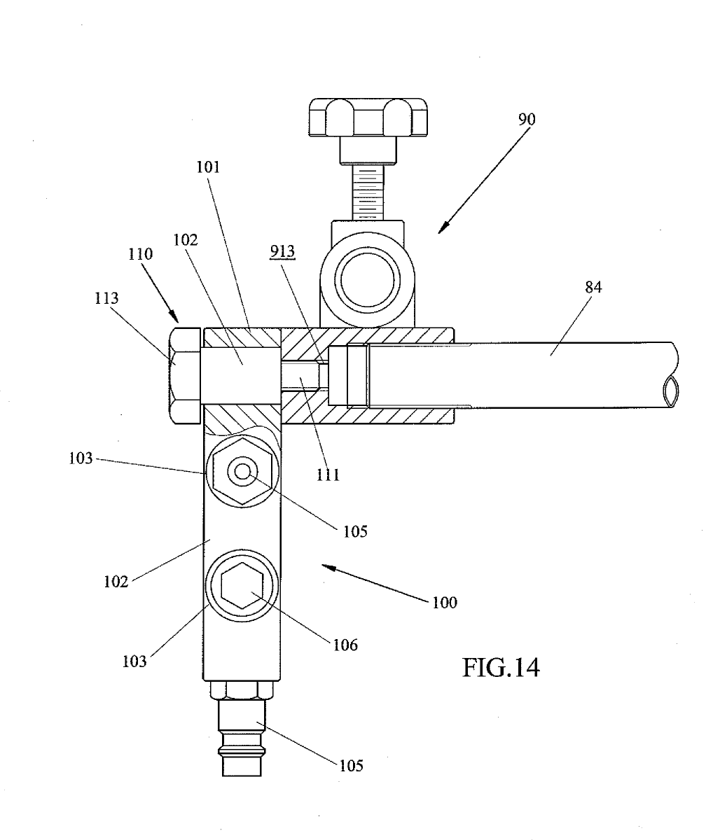

FIGS. 13 to 15 further include a rotatable inlet unit 100 and a bolt 110, wherein the rotatable inlet unit 100 includes a pivotable member 101 and a main body 102 is connected to the pivotable member 101. Three connection ports 103 are defined in two sides of the main body 102 and an underside of the main body 102. Each connection port 103 includes a threaded hole 104 and the three threaded holes 104 are in communication with each other. A connection end 105 or a nut are used to be connected with each of the threaded holes 104.

The bolt 110 includes a shank 112 which is connected between a threaded section 111 and a hexagonal head 113. The threaded section 111 is connected to second inner threaded portion 913 of the horizontal sleeve unit 90 and the pivotable member 101 is mounted to the shank 112. The hexagonal head 113 restricts the movement of the pivotable member 101 in Z-axis.

The shank 112 is longer than the pivotable member 101 and the shank 112 contacts the end surface of the second inner threaded portion 913, so that the rotatable inlet unit 100 is not locked and can be rotatable.

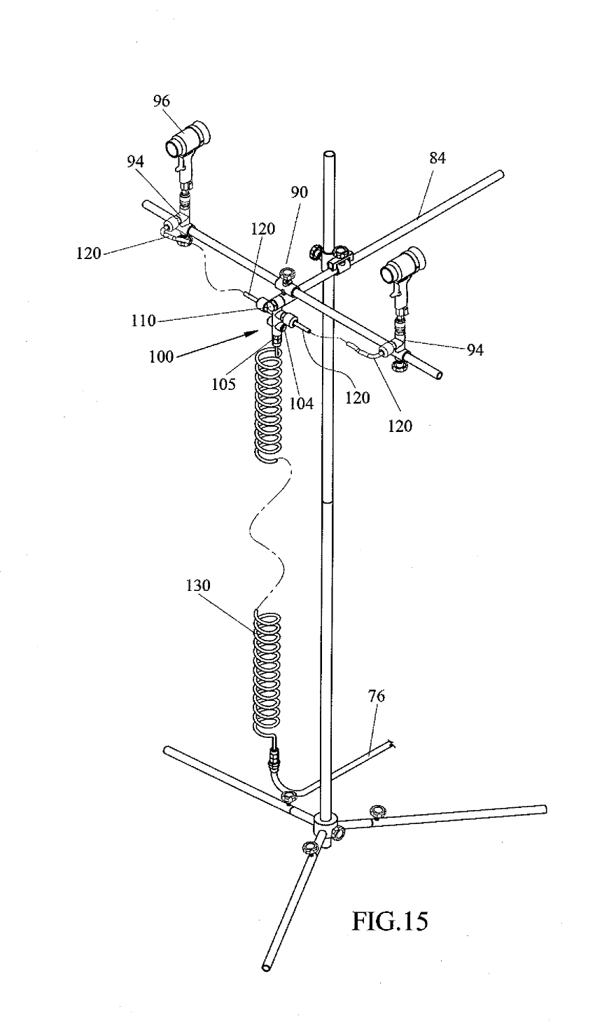

As shown in FIGS. 13 and 15, the two connection ends 105 on two sides of the rotatable inlet unit 100 can be directly connected with straight air hoses 120 which are then connected with the direr bases 94. The connection end 105 at the underside of the main body 102 is connected with a spiral hose 130 which is connected with the inlet hose 76. The rotatable inlet unit 100 is moved with the Z-axis tube 84, the drier bases 84 and the driers 96 moved in Y-axis. There is only a limited space between the rotatable inlet unit 100 and the drier bases 94 so that the straight air hose, instead of spiral hose is used. The straight air hose is 4 to 5 times cheaper than the spiral hose.

The spiral hose 130 is vertically connected between the connection end 105 and the rotatable inlet unit 100 due to gravity so that it does not touch the object or affect the drying process.

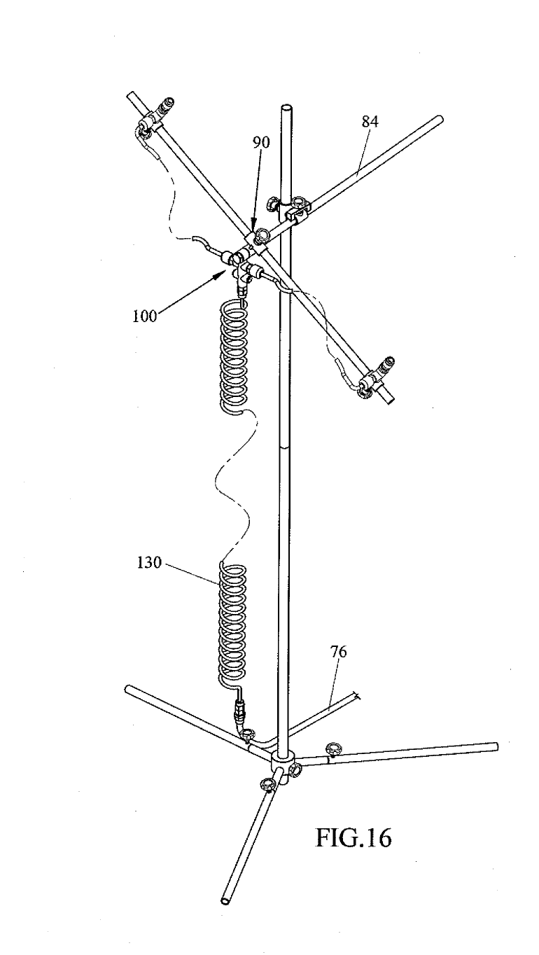

FIG. 16 shows that when Z-axis tube 84 is rotated, the rotatable inlet unit 100 does not rotated with the Z-axis tube 84 and the spiral hose 130 is kept its vertical position.

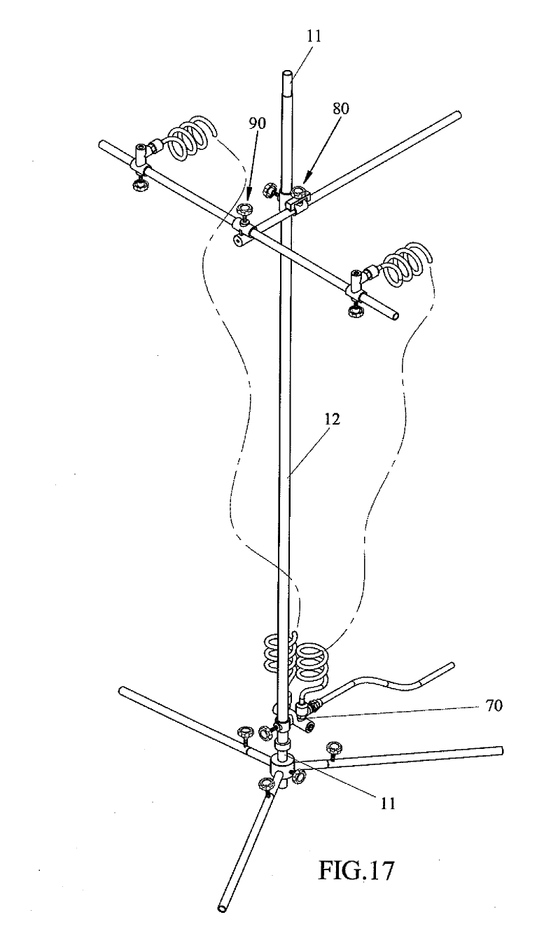

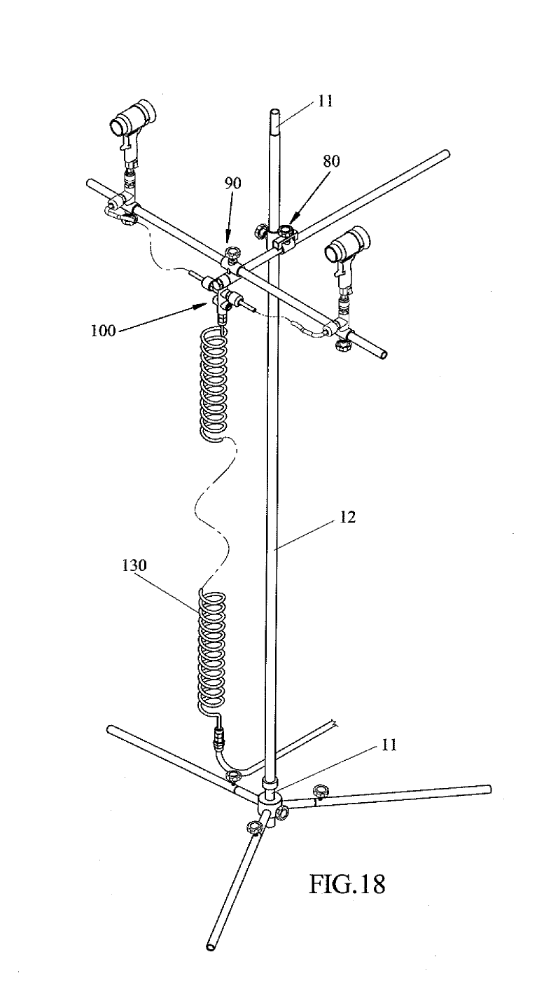

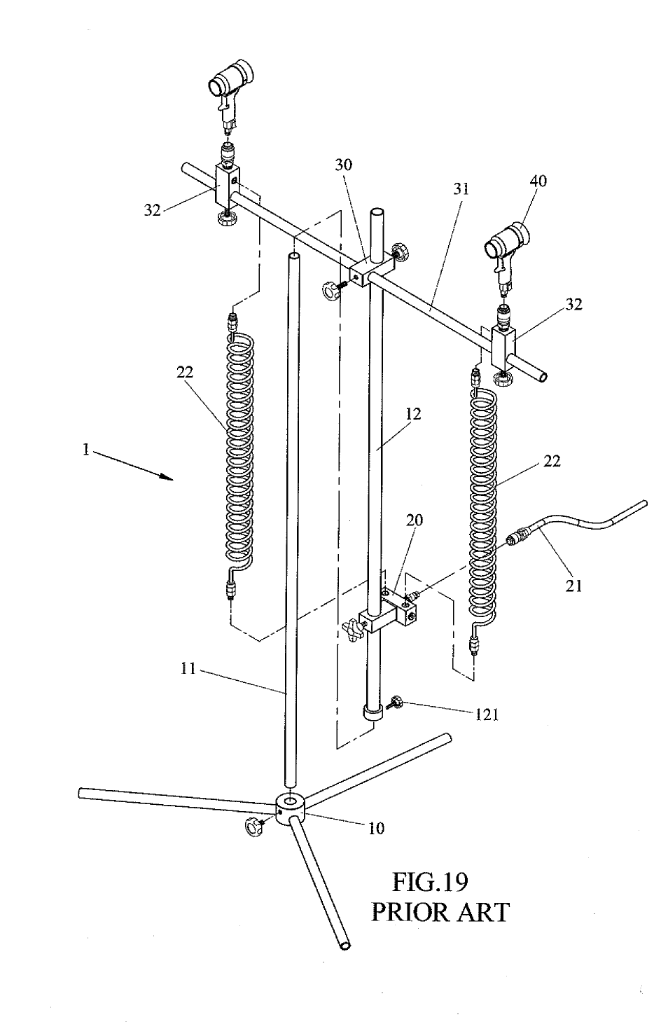

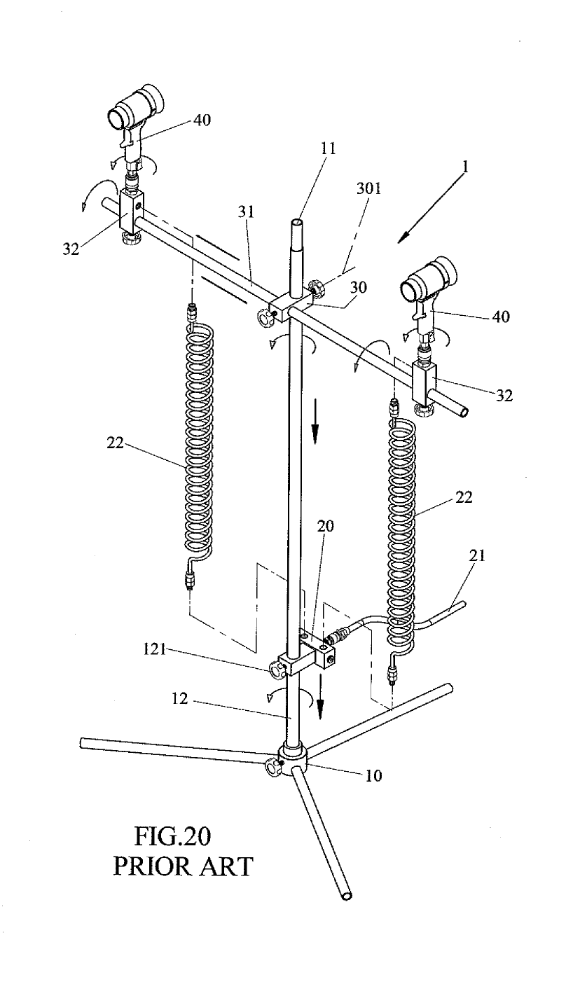

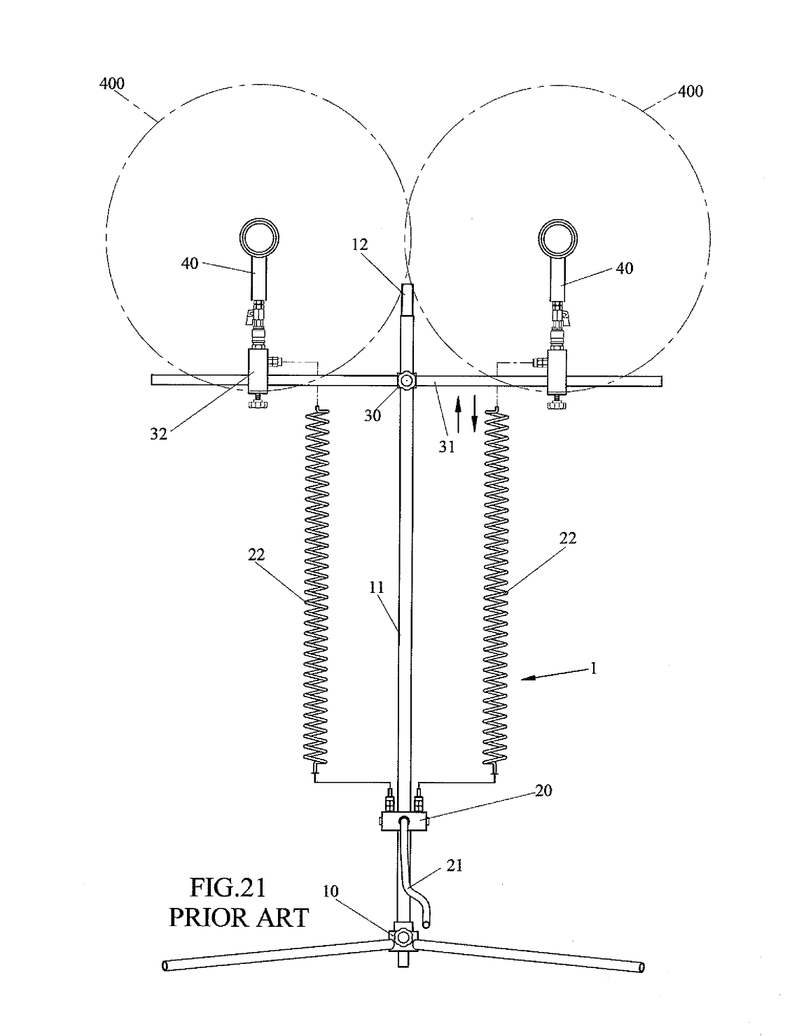

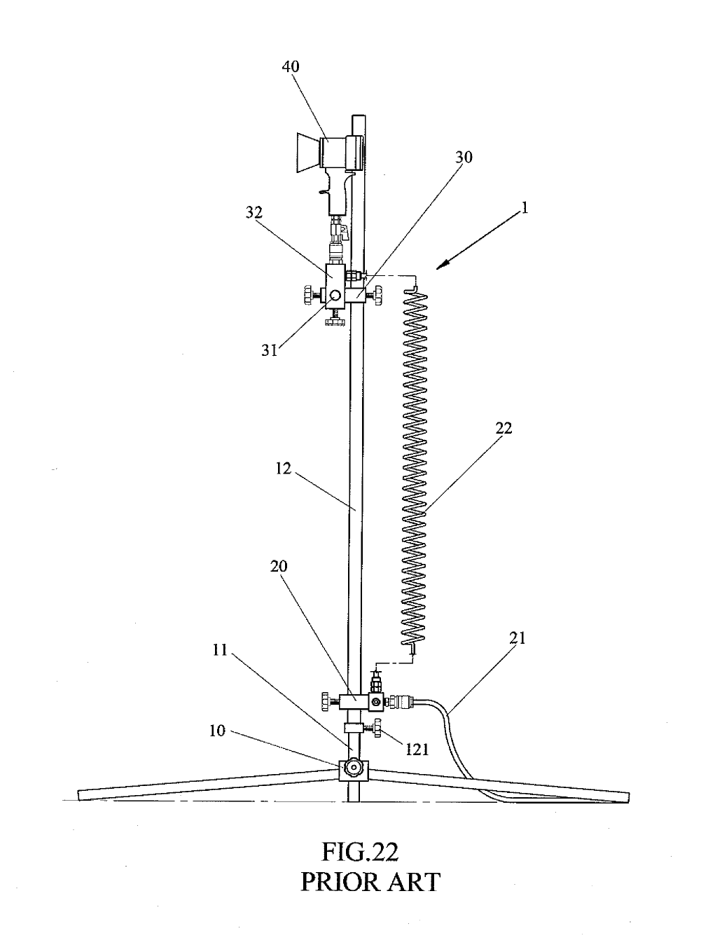

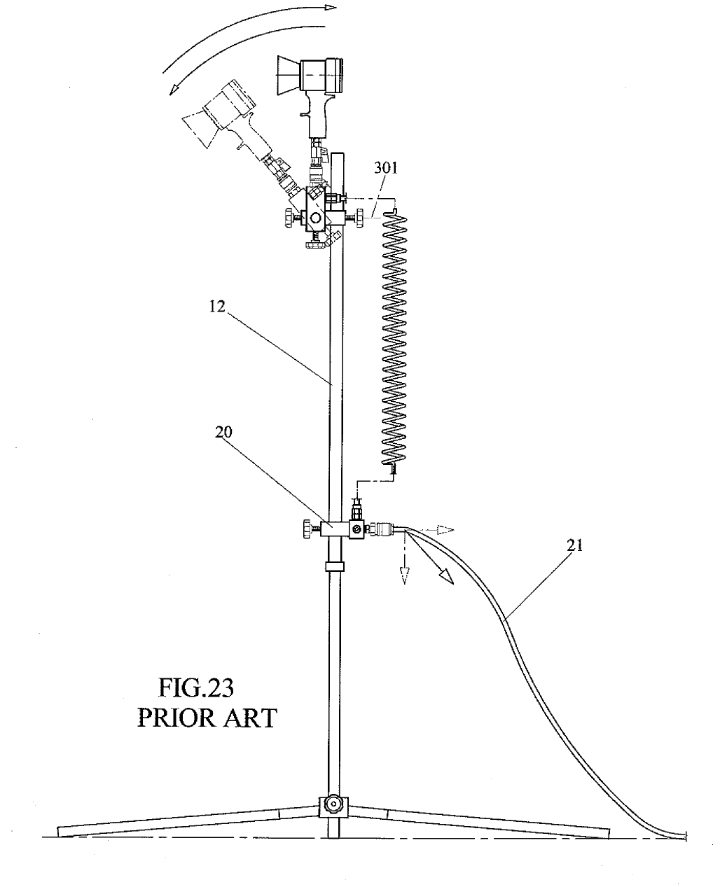

FIGS. 17 and 18 show that the inlet unit 70, the vertical sleeve unit 80, the horizontal sleeve unit 90 and the rotatable inlet unit 100 can also be used with the conventional Y-axis tube 11 and the outer tube 12.

While we have shown and described the embodiment in accordance with the present invention, it should be clear to those skilled in the art that further embodiments may be made without departing from the scope of the present invention.

What is claimed is:

1. A rack for driers, comprising:
a support (50) having a top hole (51);
a Y-axis tube set (60) connected with the top hole (51) and including a first tube (61) and a second tube (62) which is connected to the first tube (61) by a connection member (63);
an inlet unit (70) having a upright sleeve (71) which is mounted to the first tube (61) and a screw (72) threadedly extends through the upright sleeve (71), a plurality of connection members (752, 78) respectively connected to a front end and a top of the inlet unit (70);
a vertical sleeve unit (80) having a vertical sleeve (81) in Y-axis and a horizontal sleeve (82) in Z-axis, the vertical sleeve (81) movably mounted to the first tube (61) or the second tube (62), the vertical sleeve (81) including a threaded hole (821), a pressing member (83 having a top member (830 and a threaded hole (831 defined through the top member (830), a screw (85) threadedly connected to the threaded hole (821) and pressing the pressing member (83) to a Z-axis tube (84);
a horizontal sleeve unit (90) having a fixed member (91) and a horizontal sleeve (92), a stepped hole (911) defined in the fixed member (91), an X-axis tube (93) extending through the horizontal sleeve (92) and having a threaded hole (921) so that a screw (922) threadedly connected to the threaded hole (921) to fix the X-axis tube (93), and
a drier base (94) including a horizontal sleeve (941) and the X-axis tube (93) extending through the horizontal sleeve (941), a screw (943) extending through an underside of the drier base (94), a connection member (95) connected to a top of the drier base (94) and a drier (96) connected to the connection member (95).

2. The rack as claimed in claim 1, wherein the Z-axis tube (84) includes a threaded end (841).

3. The rack as claimed in claim 1, wherein two side blocks (832) extend from two ends of the top member (831) of the pressing member (83).

4. The rack as claimed in claim 3, wherein the pressing member (83) is mounted on the horizontal sleeve (82) and a distance is defined between an underside of the top member (831) and a top surface of the threaded hole (821).

5. The rack as claimed in claim 3, wherein an underside (833) of each side block (832) is a curved surface which matches with the Z-axis tube (84).

6. The rack as claimed in claim 5, wherein the underside (833) of each side block (832) is a rough surface.

7. The rack as claimed in claim 1, wherein the stepped hole (911) in the fixed member (91) includes a first inner threaded portion (912) and a second inner threaded portion (913).

8. The rack as claimed in claim 7, wherein the first inner threaded portion (912) is longer than the second inner threaded portion (913), the Z-axis tube (84) is threadedly connected to the first inner threaded portion (912), the second inner threaded portion (913) defined through the horizontal tube (92).

9. The rack as claimed in claim 1, wherein a rotatable inlet unit (100) includes a pivotable member (101) and a main body (102) is connected to the pivotable member (101), three connection ports (103) are defined in two sides of the main body (102) and an underside of the main body (102), a bolt (110) includes a shank (112) which is connected between a threaded section (111) and a hexagonal head (113), the threaded section (111) is connected to second inner threaded portion (913) of the horizontal sleeve unit (90), the pivotable member (101) is mounted to the shank (112).

10. The rack as claimed in claim 9, wherein the connection ports (103) of the rotatable inlet unit (100) each have a threaded hole (104) and the three respective threaded holes (104) communicates with each other so as to be connected with a connection end (105) or a nut.
